(19) United States
(12) Patent Application Publication
(10) Pub. No.: US 2015/0365578 A1
(43) Pub. Date: Dec. 17, 2015

(54) Method For Obtaining Images With Exposure Compensation And Imaging Apparatus With Exposure Compensation

(71) Applicant: Yung-Chien Yang, Taipei City (TW)

(72) Inventor: Yung-Chien Yang, Taipei City (TW)

(21) Appl. No.: 14/301,780

(22) Filed: Jun. 11, 2014

(51) Int. Cl. H04N 5/235; H04N 5/225; H04N 5/232

(52) U.S. Cl. CPC H04N 5/2352; H04N 5/23229; H04N 5/2355; H04N 5/2258

(57) ABSTRACT

Disclosed are a method and an apparatus for obtaining images with exposure compensation image. Images of different levels of exposures are captured and obtained, and then the captured images are combined directly into a combined image which is an image with exposure correction. The method includes the steps of providing a prism set, performing an image capturing step and performing an image combining step. In the step of providing a prism set, the prism set has a light incident plane and three light exit planes. In the image capturing step, images are captured by an imaging apparatus installed separately at the three light exit planes, and a filter is installed before at least two of the imaging apparatuses separately. In the image combining step, the images captured by the imaging apparatuses are combined into a combined image which is an image with exposure compensation.

### FIELD OF THE INVENTION

The present invention relates to a method and apparatus for obtaining images, in particular to the method and apparatus for obtaining images with exposure compensation.

### BACKGROUND OF THE INVENTION

Regardless of the format of images (photos or videos), the problem of having excessive or insufficient exposure will cause the image to have abnormal condition such as having white or black shadows. An image is captured by a lens, so that a photo can be produced as a final product. To achieve good effect, bright color, and rich layer of the image, the quantity of light passing through the lens must be controlled precisely. The quantity of light is controlled by means of the shutter speed and aperture size of an imaging apparatus and the sensitivity of a film or an optical coupler such as a charge coupled device (CCD).

However, the brightness of an object to be photographed is changed continuously with environment and weather, so that it is necessary to adjust the quantity of light to achieve the best effect. At present, various types of software are available for editing a digital image file of a captured image, and the function of such software includes exposure compensation and correction, so that the photo can have the best effect.

There is also a conventional device for performing High Dynamic Range Imaging (HDRI or HDR) which is the technology of providing a greater dynamic exposure range (or a greater brightness difference) than the general digital image technology. Therefore, the best image can be obtained. However, such device is very expensive, and some of them cost approximately more than 10,000 US dollars, and such high price is unaffordable for the general public.

### SUMMARY OF THE INVENTION

In view of the aforementioned drawback of the prior art, it is a primary objective of the present invention to provide a method and apparatus capable of obtaining images of different exposure levels when taking a picture, and the captured images are combined directly to obtain an image with exposure correction, so as to improve the convenience of capturing images.

To achieve the aforementioned objective, the present invention provides a method for obtaining images with exposure compensation, and the method comprises the steps of providing a prism set, performing an image capturing step, and performing an image combining step. In the step of providing a prism set, the prism set has a light incident plane and three light exit planes. In the image capturing step, images are captured from by an imaging apparatus installed separately at the three light exit planes, and a filter is installed separately before at least two of the imaging apparatuses. In the image combining step, the images captured by the imaging apparatuses are combined into a combined image which is an image with exposure compensation.

In the aforementioned step, the images captured by the three imaging apparatuses includes an image with excessive exposure, an image with insufficient exposure, and an unadjusted image respectively, and these images with different levels of exposure are combined to obtain an image with a predetermined compensation. Since the present invention can achieve the expected effect without requiring any special prism, therefore the cost is much lower than the prior art.

To achieve the aforementioned objective, the present invention further provides an imaging apparatus with exposure compensation based on the aforementioned method. The imaging apparatus with exposure compensation of the present invention comprises a prism set, a first filter, a first image capturing module, a second filter, a second image capturing module and a third image capturing module.

Wherein, the prism set has a light incident plane, a first light exit plane, a second light exit plane and a third light exit plane. The first filter is installed outside the first light exit plane. The first image capturing module is installed outside the first filter and provided for capturing an image exiting the first light exit plane and then passing through the first filter. The second filter is installed outside the second light exit plane. The second image capturing module is installed outside the second filter and provided for capturing an image exiting the second light exit plane and then passing through the second filter. The third image capturing module is installed outside the third light exit plane and provided for capturing an image exiting the third light exit plane. The image processing unit is electrically coupled to the first image capturing module, the second image capturing module and the third image capturing module for receiving and combining the images captured by the first image capturing module, the second image capturing module and the third image capturing module. The combined image is an image with exposure compensation.

Preferably, the first filter is a neutral density filter for adjusting the exposure value.

Preferably, the second filter is an electronic control variable neutral density filter for adjusting different exposure values to achieve the effect of making changes according to different factors such as space and weather.

Preferably, the prism set further includes a first prism, and the first prism has a first prism light incident plane, a first prism light exit plane and the third light exit plane. The second prism has a second prism light incident plane, a second prism light exit plane and the first light exit plane, and the second prism light incident plane and the first prism light exit plane abut against each other. The third prism has a third prism light incident plane and the second light exit plane, and the third prism light incident plane and the second prism light exit plane abut against each other. The prism set refracts an image in a same area to three different exit planes, which is provided for other devices to read.

The technical characteristics, contents and advantages of the present invention will become clearer in light of the following detailed description of an illustrative embodiment of this invention described in connection with the drawings. It is intended that the embodiments and drawings disclosed herein are to be considered illustrative rather than restrictive.

### BRIEF DESCRIPTION OF THE DRAWINGS

FIG. 1 is a flow chart of the method in accordance with a preferred embodiment of the present invention;

FIG. 2 is a top view of an imaging apparatus with exposure compensation in accordance with a preferred embodiment of the present invention;

FIG. 3 is a schematic view showing the light path of an imaging apparatus with exposure compensation in accordance with a preferred embodiment of the present invention; and

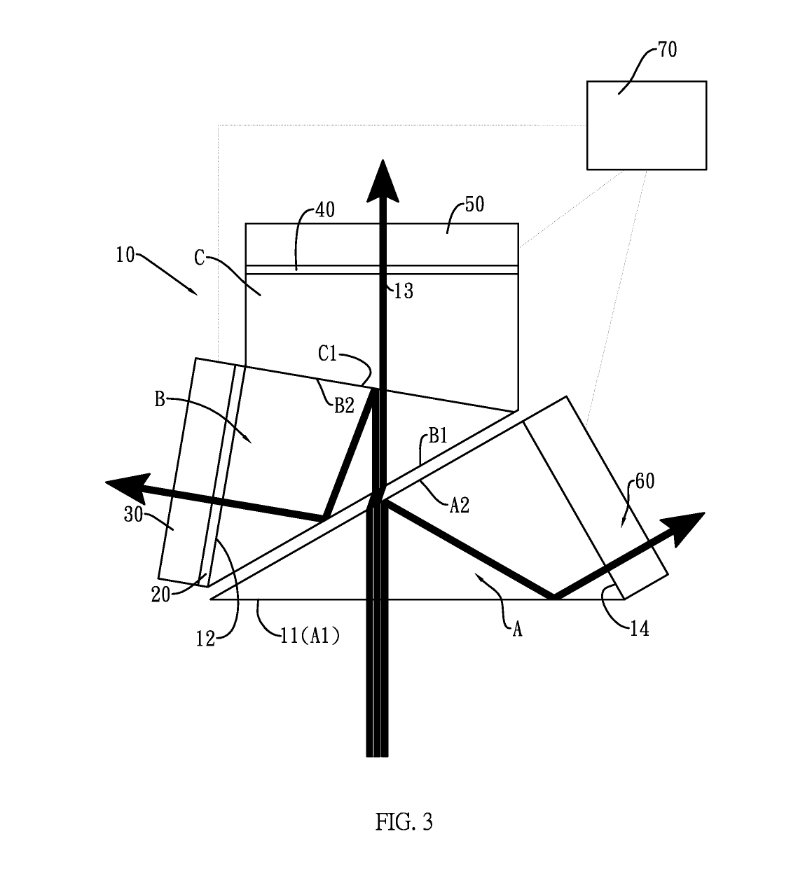

FIG. 4 is a schematic view of an imaging apparatus with exposure compensation in accordance with another preferred embodiment of the present invention.

### DESCRIPTION OF THE PREFERRED EMBODIMENTS

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

In this preferred embodiment, light is transmitted for the purpose of illustrating the invention, but we also know that image is formed by light transmission, so that the light path represents the path of the image transmission.

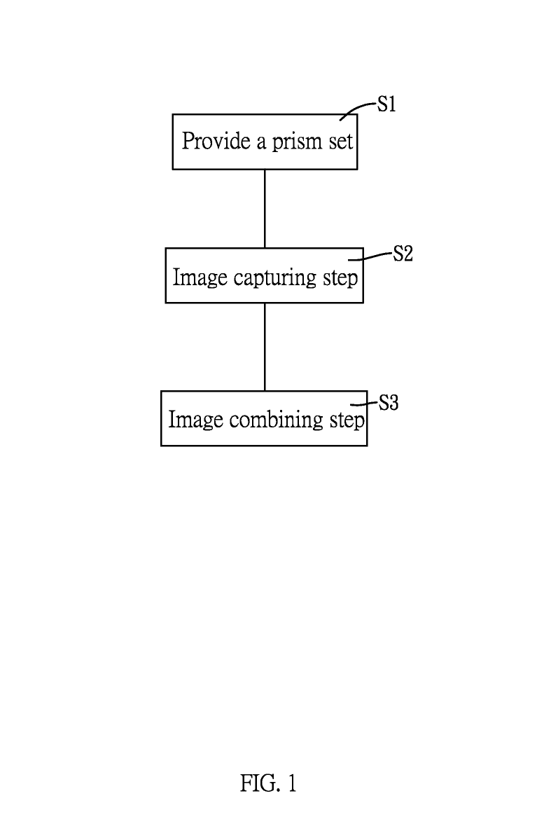

With reference to FIG. 1 for a method for obtaining images with exposure compensation in accordance with a preferred embodiment of the present invention, the method comprises the steps of providing a prism set S1, an image capturing step S2 and an image combining step S3.

S1: Provide a prism set, and the prism set has a light incident plane and three light exit planes.

S2: Perform an image capturing step, wherein images are captured by an imaging apparatus installed at the three light exit planes, and a filter is installed before at least two of the imaging apparatuses.

S3: Perform an image combining step, wherein the images captured by the imaging apparatuses are combined to form a combined image, which is an image with exposure compensation.

By the aforementioned steps, a light is divided into three lights to be emitted successively, and then different filters or no filters are installed at the imaging apparatuses, so that each imaging apparatus obtains images of normal condition, excessive exposure and insufficient exposure, and these three types of images are combined to obtain an image with exposure correction. This method can achieve the expected effect without requiring expensive equipments, and it can be applied for capturing static images (such as photos) or dynamic images (such as videos), and the simple design reduces the level of difficulty of the manufacture.

Based on the aforementioned method, the present invention further provides an embodiment of an imaging apparatus with exposure compensation, the imaging apparatus comprises a prism set 10, a first filter 20, a first image capturing module 30, a second filter 40, a second image capturing module 50, a third image capturing module 60 and an image processing unit 70.

The prism set 10 has a light incident plane 11, a first light exit plane 12, a second light exit plane 13 and a third light exit plane 14. The first filter 20 is installed outside the first light exit plane 12. The first image capturing module 30 is installed outside the first filter 20 and provided for capturing an image refracting from the first light exit plane 12 and then passing through the first filter 20. The second filter 40 is installed outside the second light exit plane 13. The second image capturing module 50 is installed outside the second filter 40 and provided for capturing an image exiting the second light exit plane 13 and then passing through the second filter 40. The third image capturing module 60 is installed outside the third light exit plane 14 and provided for capturing an image exiting the third light exit plane 14. The image processing unit 70 is electrically coupled to the first image capturing module 30, the second image capturing module 50 and the third image capturing module 60 for receiving and combining the images captured by the first image capturing module 30, the second image capturing module 50 and the third image capturing module 60 into a combined image, and the combined image is an image with exposure compensation.

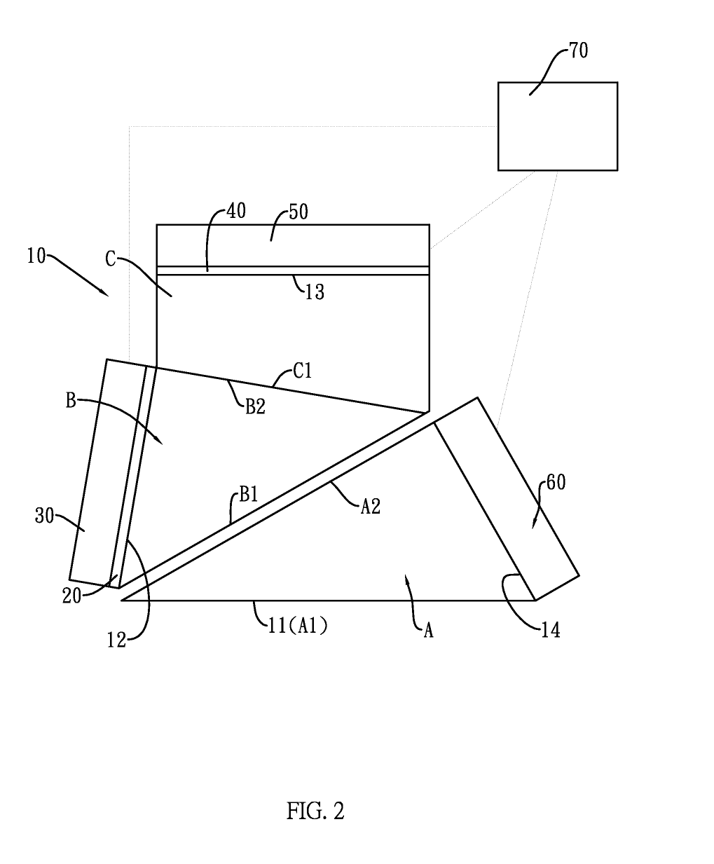

With reference to FIG. 2, the arrowheads as shown in the figure indicate the light paths of the three lights divided by the prism set 10, and a light is divided by the prism set 10 into three lights to be emitted in three directions. Although there are three arrowheads in the figure, yet they are provided to make the reading easier. In fact, a single light is divided into three lights which are emitted in three directions respectively.

In addition, the first filter 20 may be a neutral density filter, and the second filter 40 may be an electronic control variable neutral density filter. Different neutral density filters may affect the level of exposure, and then the electronic control variable neutral density filter capable of adjusting the filtering level is used to make adjustments according to the environment, so as to improve the flexibility of making adjustments.

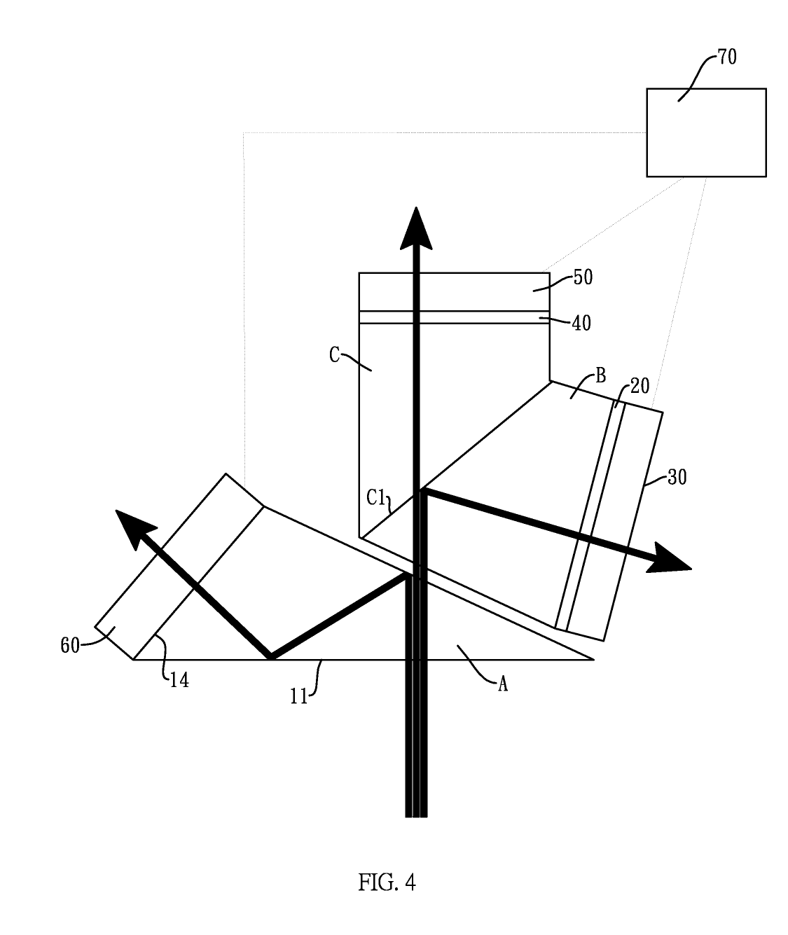

With reference to FIG. 1 for the prism set 10 in accordance with this preferred embodiment, the prism set 10 includes a first prism A, a second prism B and a third prism C. The first prism A has a first prism light incident plane A1 (which is a light incident plane 11), a first prism light exit plane A2 and the third light exit plane 14. The second prism B has a second prism light incident plane B1, a second prism light exit plane B2 and the first light exit plane 12, and the second prism light incident plane B1 and the first prism light exit plane A2 are disposed adjacent to each other. The third prism C has a third prism light incident plane C1 and the second light exit plane 13, and the third prism light incident plane C1 and the second prism light exit plane B2 are disposed adjacent to each other. This type of prism set 10 can achieve the effect of dividing the same light into three lights and outputting the three lights. Of course, the prism set 10 of the present invention may be of another form, and the shape is not limited to the aforementioned one. For example, the prism set may be in the form as shown in FIG. 4 to achieve the effect of outputting three lights.

While the invention has been described by means of specific embodiments, numerous modifications and variations could be made thereto by those skilled in the art without departing from the scope and spirit of the invention set forth in the claims.

What is claimed is:

1. A method for obtaining images with exposure compensation, comprising the steps of:
providing a prism set having a light incident plane and three light exit planes;
performing an image capturing step on the three light exit planes by an imaging apparatus and installing a filter in front of at least two of the imaging apparatuses separately; and
performing an image combining step to combine the image captured by each imaging apparatus into a combined image, which is the image with exposure compensation.

2. An imaging apparatus with exposure compensation, comprising:
a prism set, having a light incident plane, a first light exit plane, a second light exit plane and a third light exit plane;
a first filter, installed outside the first light exit plane;
a first image capturing module, installed outside the first filter, for capturing an image exiting from the first light exit plane and passing through the first filter;
a second filter, installed outside the second light exit plane;
a second image capturing module, installed outside the second filter, for capturing an image exiting from the second light exit plane and passing through the second filter;
a third image capturing module, installed outside the third light exit plane, for capturing an image exiting from the third light exit plane; and
an image processing unit, electrically coupled to the first image capturing module, the second image capturing module and the third image capturing module, for receiving and combining the images captured by the first image capturing module, the second image capturing module and the third image capturing module, and the combined image being an image with exposure compensation.

3. The imaging apparatus with exposure compensation according to claim 2, wherein the first filter is a neutral density filter.

4. The imaging apparatus with exposure compensation according to claim 2, wherein the second filter is an electronic control variable neutral density filter.

5. The imaging apparatus with exposure compensation according to claim 1, wherein the prism set further comprises:
a first prism having a first prism light incident plane, a first prism light exit plane and the third light exit plane;
a second prism, having a second prism light incident plane, a second prism light exit plane and the first light exit plane, and the second prism light incident plane being disposed adjacent to the first prism light exit plane; and
a third prism, having a third prism light incident plane and the second light exit plane, and the third prism light incident plane being disposed adjacent to the second prism light exit plane.
